(19) United States
(12) Patent Application Publication
(10) Pub. No.: US 2007/0138928 A1
(43) Pub. Date: Jun. 21, 2007

(54) Method for fabricating electrode of external electrode fluorescent lamp and external electrode fluorescent lamp fabricated using the same

(75) Inventors: Young-Chul Lee, Yongin-si (KR); Sung-Jung Kim, Seoul (KR); Sung-Hae Kim, Suwon-si (KR)

Correspondence Address: c/o LADAS & PARRY, Suite 2100, 5670 Wilshire Boulevard, Los Angeles, CA, 90036-5679, US

(73) Assignee: DMS CO., LTD.

(21) Appl. No.: 11/592,494

(22) Filed: Nov. 2, 2006

(30) Foreign Application Priority Data
Dec. 20, 2005 (KR) 10-2005-0126317

(51) Int. Cl. H01J 11/00; H01J 65/00; H01J 61/06

(52) U.S. Cl. 313/234; 313/607

(57) ABSTRACT

The present invention provides a method of fabricating an electrode of an EEFL including: cutting a cylindrical tube for the electrode to a uniform size; forming a round-shape protective cap having a hole with a predetermined size at one end of the cut tube; inserting the protective cap into a glass tube having the electrode formed by electroless plating; and connecting the protective cap on an outer wall of the glass tube, after inserting the protective cap into the glass tube.

### CROSS-REFERENCE TO RELATED APPLICATION

This application claims priority to and the benefit of Korean Patent Application No. 10-2005-0126317 filed in the Korean Intellectual Property Office on Dec. 20, 2005, the entire content of which is incorporated herein by reference.

### BACKGROUND OF THE INVENTION

1. Field of the Invention

The present invention relates to a method for fabricating an electrode of an external electrode fluorescent lamp (EEFL) and an EEFL fabricated using the same, and more particularly, to a method for fabricating an electrode of an EEFL and an EEFL fabricated using the same, in which the EEFL may be used as a backlight, which is applied as a light source for a flat panel display, and may be mass produced using a simple fabricating method, and in which the use of lead or non-lead solder is minimized when a protective cap is connected. The fabricating method of the electrode of the EEFL includes: cutting a cylindrical tube for the electrode to a uniform size; forming a round shape protective cap at one end of the cut tube having a hole of a predetermined size; inserting the protective cap into a glass tube having an electrode formed by electroless plating; and connecting a pair of the protective caps respectively on outer walls of both ends of the glass tube.

2. Description of Related Art

Generally, an EEFL includes a glass tube, a discharge gas including a mixture of neon and argon, and mercury, in which the discharge gas is sealed inside the glass tube. Also, the EEFL includes a fluorescent layer on an inner wall, and has external electrodes disposed at both ends. The external electrodes each have a thin cylindrical copper layer, as shown in FIG. 8, disposed on the glass tube to facilitate a discharge in the EEFL by an electric power source supplied externally. Furthermore, the copper layer is connected with the glass tube by lead or non-lead solder filled between the copper layer and the glass tube by dipping the glass tube into a molten bath of the lead or non-lead solder for a specific period of time. That is, an EEFL produced by a prior art method as shown in FIG. 9 includes: disposing a cylindrical protective cap 103 having a tension at one end of a glass tube 101; and dipping the glass tube 101 into a molten bath of lead or non-lead solder, thereby connecting the glass tube 101 with the protective cap 103 by an adhesive layer 102 formed of the solidified lead or non-lead solder. Although it is necessary for the tube of the electrode to have a uniform tension, it is difficult to produce a proper shape having a tension satisfying design requirements, such that the production of a low quality product often results. Also, during the dipping process to connect the protective cap 103 with the glass tube 101, the lead or non-lead solder consumption increases. This makes it necessary to perform an additional post-treatment process prior to performing finishing processes of the protective cap 103.

### SUMMARY OF THE INVENTION

It is an object of the present invention to solve the above-described problems, and to provide a method of fabricating an electrode of an EEFL and an EEFL fabricated using the same, in which the method allows for a reduction in a defect rate while producing a protective cap, as well as a reduction in the consumption of the lead or non-lead solder used for connecting the protective cap with a glass tube. In order to achieve the above object, the present invention provides a method of fabricating an electrode of an EEFL including: cutting a cylindrical tube for the electrode to a uniform size; forming a round protective cap at one end of the cut tube having a hole of a predetermined size; inserting the protective cap into a glass tube having an electrode formed by electroless plating; and connecting a pair of the protective caps respectively on outer walls of both ends of the glass tube.

The connecting of the protective cap with the glass tube may be conducted by dipping the protective cap and the glass tube into a molten bath of the lead or non-lead solder.

Also, the connecting of the protective cap with the glass tube may be conducted by inserting the glass tube into the protective cap while performing heat treatment after inserting a lead or non-lead solder ball into the protective cap.

Before inserting the protective cap into the glass tube, metal plating on an outer wall of the electrode of the glass tube may be conducted, after which the protective cap may be connected with the glass tube by the heat treatment.

It is preferable to have different hole sizes provided to the protective cap.

The present invention provides a method of fabricating an electrode of an EEFL including: cutting a cylindrical tube for the electrode to a uniform size; connecting the cut tube with a supporting cap having a hole in order to form a protective cap; inserting the protective cap into a glass tube having an electrode formed by electroless plating; and connecting a pair of the protective caps respectively on outer walls of both ends of the glass tube.

It is preferable for the supporting and protective caps to have different hole sizes.

The present invention provides an EEFL including electrodes formed by electroless plating at the both ends of a glass tube and protective caps connected with outer walls of the electrodes, in which one end of each of the protective caps is a round shape having different sizes of holes.

The present invention provides an EEFL including electrodes formed by electroless plating at both ends of a glass tube and protective caps connected respectively with outer walls of the electrodes, in which each of the protective caps is cylindrical and connected with a supporting cap having a smaller hole size than a hole of the protective cap.

### BRIEF DESCRIPTION OF THE DRAWINGS

FIG. 1 is a perspective view of an EEFL illustrating an embodiment of the present invention.

FIG. 2 is a detailed view of an electrode portion of FIG. 1 illustrating a first embodiment of the present invention.

FIG. 3 is a perspective view of a cut tube for an electrode before being formed to the electrode portion of FIG. 2.

FIG. 4 is a flow chart illustrating consecutive manufacturing processes of the first embodiment of the present invention.

FIG. 5 is a detailed view of the electrode portion of FIG. 1 illustrating a second embodiment of the present invention.

FIG. 6 is an exploded perspective view of FIG. 5.

FIG. 7 is a flow chart illustrating consecutive manufacturing processes of the second embodiment of the present invention.

FIG. 8 is a perspective view of a conventional protective cap.

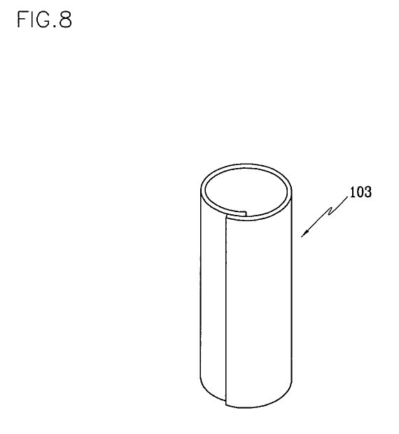

FIG. 9 is a partial sectional view of a part of an electrode portion of the EEFL illustrating the protective cap of FIG. 8 in an applied state.

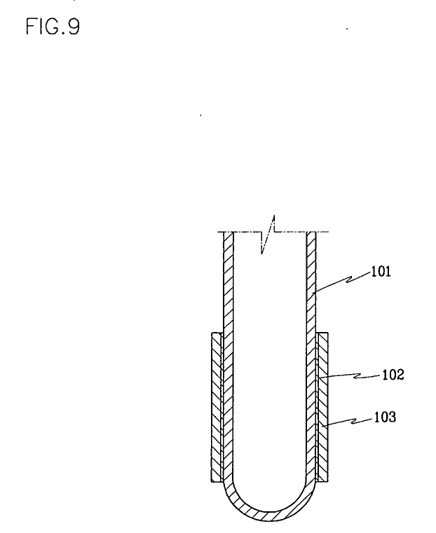

### DETAILED DESCRIPTION OF THE INVENTION

Reference will now be made in detail to the preferred embodiments of the present invention, examples of which are illustrated in the accompanying drawings.

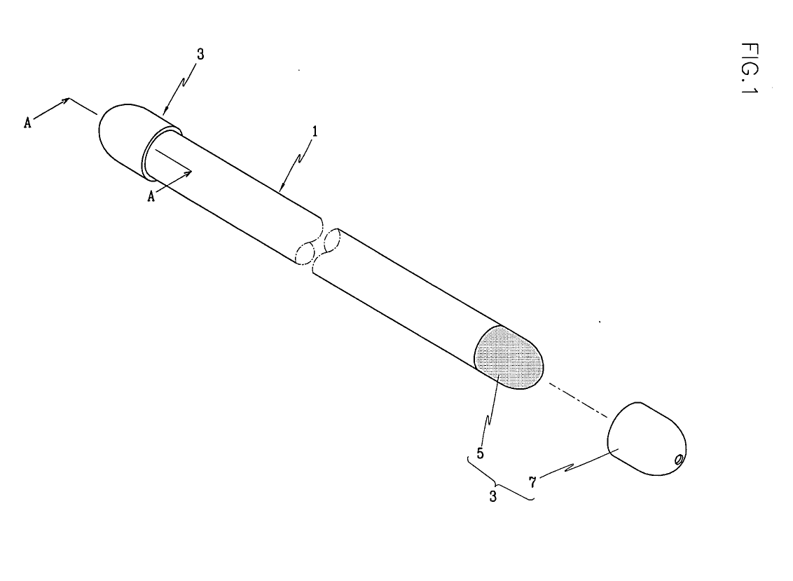

FIG. 1 is a perspective view of an EEFL illustrating an embodiment of the present invention. The EEFL of the present invention includes a glass tube 1 and electrode portions 3 disposed respectively at both ends of the glass tube 1. The glass tube 1 includes a discharge gas filled therein and a fluorescent layer (not shown in FIG. 1) emitting light by luminescence when discharge occurs. The electrode portions 3 are disposed respectively at both ends of the glass tube 1 and an electric power source is provided to the electrode portions 3 in order to generate discharge inside the glass tube 1.

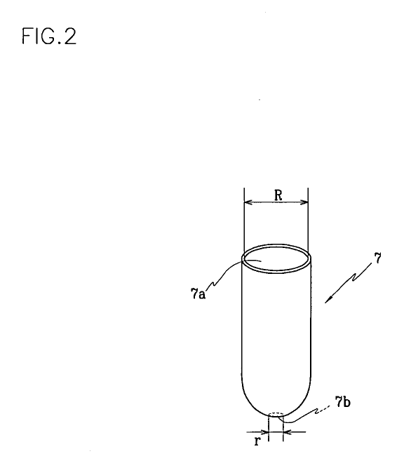

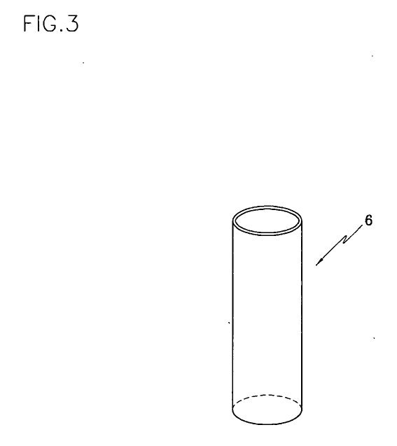

The electrode portions 3 include electroless plate layers 5 forming electrodes at both ends of the glass tube 1 by electroless plating, and protective caps 7 connected on outer walls of the electroless plate layers 5 in order to protect the electroless plate layers 5. The electroless plate layers 5 may be formed of electroless nickel plating. Each of the protective caps 7 connected on the outer wall of a respective one of the electroless plate layers 5, as shown in FIG. 2, has a hole 7a provided on one end having a diameter R, and another hole 7b provided on the other end having a diameter r that is smaller than the diameter R. That is, a cylindrical tube 6 formed of a brass (copper, aluminum, or an alloy including copper and aluminum) is cut to a uniform size (shown in FIG. 3), and then one end of the cut tube is formed into a round shape. The tube 6 shown in FIG. 3 is the uniformly cut cylindrical tube before having the round shape formed at the one end. Preferably, the diameter for the hole 7b provided at the one end having the round shape is smaller than the diameter for the hole 7a provided on the other end. A bar shape supporting bar (not shown) may be inserted inside the cylindrical tube 6, after which the tube 6 may be adhered to a round shape jig in order to form the round shape. The process of forming a round shape of the cylindrical tube 6 is not limited to the above-described method, and any method to form a round shape at one end with a hole of certain diameter may be used.

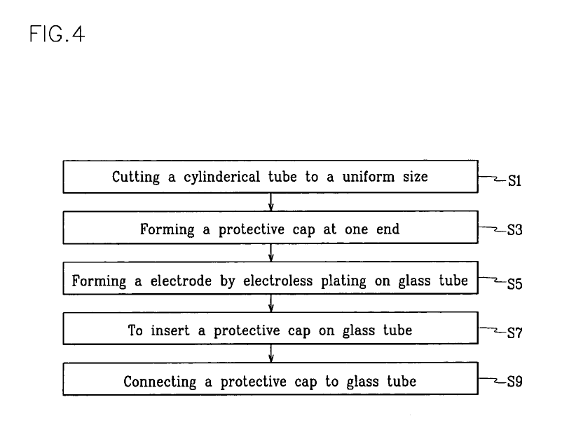

FIG. 4 is a flow chart illustrating consecutive processes of fabricating the electrode portion 3 according to the first embodiment of the present invention. First, a cylindrical tube is cut to a uniform size, in step S1. Subsequently, the protective cap 7 having the round shape at one end is formed while maintaining a predetermined size of the cylindrical tube, in step S3. The forming the round shape at the one end of the protective cap 7 may be conducted by adhering the tube on a hemispherical jig after inserting a supporting bar (not shown) into the tube (7 in FIG. 2).

Separately, electrodes are formed on the glass tube 1 by electroless plating. That is, electrodes are formed by electroless plating on electrode regions of both ends of the glass tube, in step S5. A plurality of the glass tubes 1 may be disposed on a cassette in order to allow a large volume of the same to be processed simultaneously. Preferably, a plurality of the protective caps 7 may also be disposed on a cassette-shaped jig, in which a number of the protective caps 7 corresponds to that of the glass tubes 1. Further, a partial length (about 20% of the total length) of the plurality of protective caps 7 is dipped into a molten bath of lead or non-lead solder. Subsequently, the glass tubes 1 are inserted into the protective caps 7, in step S7. At this point, the holes 7b provided in the protective caps 7 are preferably facing in the bottom direction. The cassettes having the glass tubes 1 connected with the protective caps 7 are lifted simultaneously. Next, while being lifted, the protective caps 7 are connected with the electrodes of the glass tubes 1 by solidification of the lead or the non-lead solder filled between the electrodes and the protective caps 7, in which the electrodes are the electroless plate layers 5 formed on the glass tubes 1, in step S9. The holes 7b provided in the protective caps 7 have a smaller size than the holes 7a disposed relatively higher, thereby reducing a drain speed of the lead or non-lead solder considerably when the protective caps 7 are lifted after the dipping process. Therefore, the lead or non-lead solder connecting the electrodes of the glass tubes 1 with the protective caps 7 undergoes minimal downward dripping, and solidification occurs when the protective caps 7 are lifted after the dipping process, such that a post-treatment process of removing the lead or non-lead solder may be reduced or omitted.

The connecting of the glass tube 1 with the protective cap 7 is not limited to the above-described dipping process, and other methods described hereinafter may be used.

That is, for example, a lead or non-lead solder ball may be inserted inside the protective cap 7, and the electrode formed by the electroless plating on the glass tube 1 may be inserted into the protective cap 7 while performing a heat treatment process (providing heat). Subsequently, the provision of heat is discontinued, thereby fixing the protective cap 7 on the glass tube 1 by solidifying the lead or non-lead solder ball. Therefore, consumption of the lead or non-lead solder may be minimized.

As another example, a metal plate layer as an adhesive layer may be formed on the electrode of the glass tube 1 by electroless plating. That is, the metal plate layer may be formed of a tin having a low melting point and high electric conductivity. Of course, the metal plate layer may be formed of another metal besides tin. The protective cap 7 is connected with the electrode of the glass tube 1 by heat treating (providing heat) the adhesive layer after placing the protective cap 7 on an outer wall of the adhesive layer. Therefore, consumption of the adhesive layer fixing the protective cap 7 may be minimized, and productivity may be improved. Also, a post-treatment process of removing the lead or non-lead solder may be omitted to thereby additionally improve productivity.

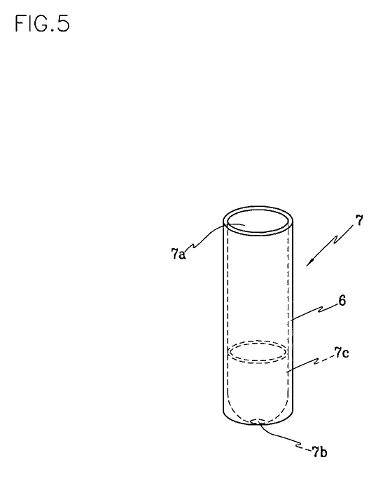

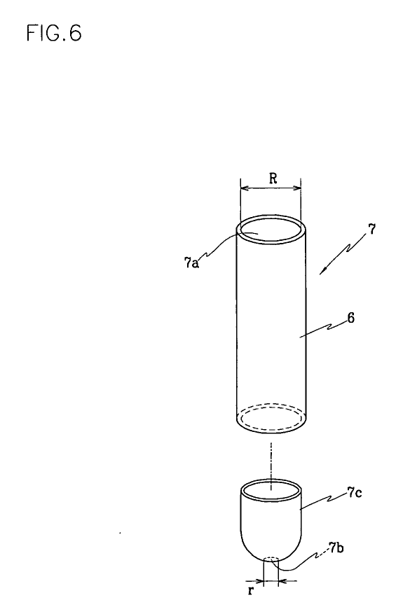

FIG. 5 is a perspective view illustrating a second embodiment of the present invention, and FIG. 6 is an exploded perspective view of FIG. 5 showing the protective cap 7 (the same reference numerals indicate elements identical to those of the first embodiment). Since some of the elements of the EEFL of this embodiment are identical to those of the EEFL of the first embodiment, only those elements that are different will be described herein. The protective cap 7 of the second embodiment includes a supporting cap 7c fixed inside the tube 6 and having a smaller hole 7b than a hole 7a provided to the uniformly cut cylindrical tube 6. The protective cap 7 of the first embodiment is produced by pressing using a jig or by using a press. However, the protective cap 7 of the second embodiment is produced by inserting the supporting cap 7c into the glass tube 6 using an intrinsic elastic force of the outer wall of the supporting cap 7c. Preferably, the hole 7b of the protective cap 7c is smaller than the hole 7a of the tube 6.

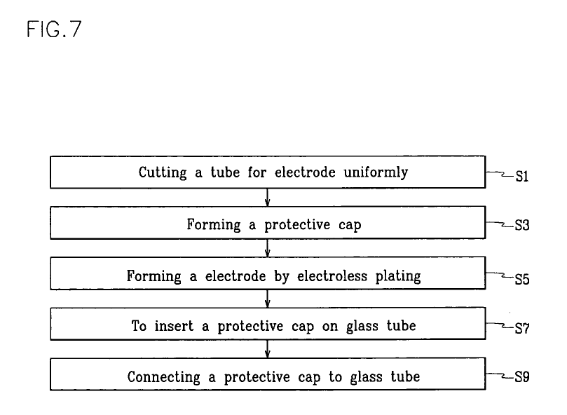

Referring to FIG. 7, a method of fabricating the electrode of the EEFL of the second embodiment will now be described.

First, the tube 6 for the electrode is uniformly cut, in step S1. Subsequently, the supporting cap 7c having the hole 7b is connected with the tube 6, in step S3. At this point, preferably, the supporting cap 7c has an intrinsic elastic force in the radial direction, and the supporting cap 7c may be adhered inside the tube 6 by the elastic force. The electrode is formed on the glass tube 1 by electroless plating, in step S5. Next, the glass tube 1 is inserted into the protective cap 7, step S7, and the glass tube 1 is connected with the protective cap 7, step S9. Processes of steps S7 and S9 of the second embodiment are identical to those of the first embodiment.

Therefore, the method of fabricating the electrode of the EEFL uses only a required amount of the lead or non-lead solder when the protective cap is fixed. Further, excessive application of the lead or non-lead solder is reduced such that a post-treatment process for removing the lead or non-lead solder is not required.

Therefore, according to the present invention, the method of fabricating the electrode is simple, is suitable for large-volume production, and reduces a defect rate considerably, thereby improving productivity. Also, when the protective cap is connected with the glass tube having the electrode formed by the electroless plating, only 20% of the protective cap is dipped into the molten bath of the lead or non-lead solder, thereby minimizing the consumption of the lead or non-lead solder. In addition, since a minimal amount of the lead or non-lead solder is used, a post-treatment process may be omitted or reduced, thereby further improving productivity.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. A method of fabricating an electrode of an EEFL comprising:
cutting a cylindrical tube to a uniform size for the electrode;
forming a round shape protective cap having a hole of a predetermined size at one end of the cut tube;
inserting the protective cap into a glass tube having the electrode formed by electroless plating; and
connecting the protective cap on an outer wall of the glass tube, after inserting the protective cap into the glass tube.

2. The method of fabricating the electrode of claim 1, wherein the connecting of the protective cap with the glass tube is conducted by dipping the glass tube into a molten bath of lead or non-lead solder.

3. The method of fabricating the electrode of claim 1, wherein the connecting of the protective cap with the glass tube is conducted by inserting the glass tube into the protective cap while performing heat treatment after a lead or non-lead solder ball is inserted into the protective cap.

4. The method of fabricating the electrode of claim 1 further comprising:
performing metal plating for adhesion on an outer wall of the electrode of the glass tube before inserting the protective cap into the glass tube; and
connecting the protective cap with the glass tube by heat treatment.

5. The method of fabricating the electrode of claim 4, wherein the metal plating is tin plating.

6. The method of fabricating the electrode of claim 1, wherein the holes provided to the protective cap have different sizes.

7. A method of fabricating an electrode of an EEFL comprising:
cutting a cylindrical tube for the electrode to a uniform size;
forming a protective cap by connecting a supporting cap comprising a hole with the cut tube;
inserting the protective cap into a glass tube comprising the electrode formed by electroless plating; and
connecting the protective cap with the glass tube after inserting the protective cap into the glass tube.

8. The method of fabricating the electrode of claim 7, wherein the connecting of the protective cap with the glass tube is conducted by dipping the protective cap and the glass tube into a molten bath of lead or non-lead solder.

9. The method of fabricating the electrode of claim 7, wherein the connecting of the protective cap with the glass tube is conducted by inserting the glass tube into the protective cap while performing heat treating after a lead or non-lead solder ball is inserted into the protective cap.

10. The method of fabricating the electrode of claim 7, further comprising:
performing metal plating for adhesion on an outer wall of the electrode of the glass tube before inserting the protective cap into the glass tube; and
connecting the protective cap with the glass tube by heat treatment.

11. The method of fabricating the electrode of claim 10, wherein the metal plating is tin plating.

12. The method of fabricating the electrode of claim 7, wherein the hole formed in the supporting cap and a hole formed in the tube have different sizes.

13. An EEFL comprising:
a glass tube;
electrodes formed by electroless plating at both ends of the glass tube; and
protective caps connected with outer walls of the electrodes, wherein the protective caps are cylindrical with a round shape at one end, and have different hole sizes disposed at each end.

14. An EEFL comprising:
a glass tube;
electrodes formed by electroless plating at both ends of the glass tube; and
protective caps connected with outer walls of the electrodes, wherein the protective caps are cylindrical and comprise a supporting cap connected to one end of the protective cap provided with a larger hole than a hole of the supporting cap.
